(19) United States
(12) Patent Application Publication
(10) Pub. No.: US 2012/0105581 A1
(43) Pub. Date: May 3, 2012

(54) 2D TO 3D IMAGE AND VIDEO CONVERSION USING GPS AND DSM

(75) Inventors: Alexander Berestov, San Jose, CA (US); Chuen-Chien Lee, Pleasanton, CA (US)

(73) Assignee: SONY CORPORATION, Tokyo (JP)

(21) Appl. No.: 12/916,015

(22) Filed: Oct. 29, 2010

(51) Int. Cl. H04N 13/00; H04N 13/02

(52) U.S. Cl. 348/43; 348/46; 348/E13.002; 348/E13.074

(57) ABSTRACT

Converting two dimensional images to three dimensional images using Global Positioning System (GPS) data and Digital Surface Models (DSMs) is described herein. DSMs and GPS data are used to position a virtual camera. The distance between the virtual camera to the DSM is used to reconstruct a depth map. The depth map and two dimensional image are used to render a three dimensional image.

### FIELD OF THE INVENTION

The present invention relates to the field of imaging. More specifically, the present invention relates to conversion of two dimensional (2D) data to three dimensional (3D) data using Global Positioning System (GPS) information and Digital Surface Models (DSM).

### BACKGROUND OF THE INVENTION

Three dimensional technology has been developing for over a century, yet has never been able to establish itself in the mainstream generally due to complexity and cost for the average user. The emergence of Liquid Crystal Display (LCD) and Plasma screens which are better suited to rendering 3D images than traditional Cathode Ray Tube (CRT) monitors and televisions in both consumer electronics and the computer world has spurred interest in the technology. 3D systems have progressed from being technical curiosities and are now becoming practical acquisition and display systems for entertainment, commercial and scientific applications. With the boost in interest, many hardware and software companies are collaborating on 3D products.

NTT DoCoMo unveiled the Sharp mova SH251iS handset which is the first to feature a color screen capable of rendering 3D images. A single digital camera allows its user to take two dimensional (2D) images and, then using an editing system, convert them into 3D. The 3D images are sent to other phones with the recipient able to see the 3D images if they own a similarly equipped handset. No special glasses are required to view the 3D images on the auto-stereoscopic system. There are a number of problems with this technology though. In order to see quality 3D images, the user has to be positioned directly in front of the phone and approximately one foot away from its screen. If the user then moves slightly he will lose focus of the image. Furthermore, since only one camera is utilized, it can only take a 2D image and then via the 3D editor, the image is artificially turned into a 3D image. Quality of the image is therefore an issue.

The display can be improved though by utilizing a number of images, each spaced apart by 65 mm. With a number of images, the viewer can move his head left or right and will still see a correct image. However, there are additional problems with this technique. The number of cameras required increases. For example, to have four views, four cameras are used. Also, since the sets of numbers are repeating, there will still be a position that results in a reverse 3D image, just fewer of them. The reverse image can be overcome by inserting a null or black field between the repeating sets. The black field will remove the reverse 3D issue, but then there are positions where the image is no longer 3D. Furthermore, the number of black fields required is inversely proportional to the number of cameras utilized such that the more cameras used, the fewer black fields required. Hence, the multi-image display has a number of issues that need to be overcome for the viewer to enjoy his 3D experience.

### SUMMARY OF THE INVENTION

Converting two dimensional images to three dimensional images using Global Positioning System (GPS) data and Digital Surface Models (DSMs) is described herein. DSMs and GPS data are used to position a virtual camera. The distance between the virtual camera to the DSM is used to reconstruct a depth map. The depth map and two dimensional image are used to render a three dimensional image.

In one aspect, a device for converting two dimensional data to three dimensional data comprises a location component for providing location information of the two dimensional data, a digital surface model component for providing digital surface information, a depth map component for generating a depth map of the two dimensional data and a conversion component for converting the two dimensional data to the three dimensional data using the depth map. The device further comprises a screen for displaying the three dimensional data. The location information comprises global positioning system data. The digital surface information comprises a digital surface model. Generating the depth map comprises utilizing the location information to determine a position of the two dimensional data on the digital surface information and determining distances of elements of the two dimensional data. Device settings information is used in generating the depth map by helping determine the position of the two dimensional data on the digital surface information. The device settings information comprise at least one of compass information, lens information, zoom information and gyroscope information. The two dimensional data is selected from the group consisting of an image and a video.

In another aspect, a method of converting two dimensional data to three dimensional data programmed in a memory on a device comprises acquiring the two dimensional data, determining a configuration of the two dimensional data on a digital surface model using global positioning system data, determining distances of objects in the two dimensional data and the digital surface model, generating a depth map using the distances determined and rendering the three dimensional data using the depth map and the two dimensional data. The method further comprises acquiring the digital surface model and the global position system data. The method further comprises displaying the three dimensional data on a display. Determining the configuration of the two dimensional data on the digital surface model includes using the global positioning system data to locate a general area of the digital surface map and then determining an orientation of the two dimensional data by mapping a landmark of the two dimensional data and the digital surface model. Device settings information is used in determining the configuration of the two dimensional data on the digital surface model. The device settings information comprise at least one of compass information, lens information, zoom information and gyroscope information. The two dimensional data is selected from the group consisting of an image and a video. Determining the configuration, determining the distances, generating the depth map and rendering the three dimensional data occur on at least one of a server device, a camera, a camcorder, a personal computer or a television.

In another aspect, a method of converting two dimensional data to three dimensional data comprises sending the two dimensional data to a server device, matching a position of the two dimensional data with a digital surface model, generating a depth map using the position and rendering the three dimensional data using the depth map and the two dimensional data. The server device stores the digital surface model. Sending the two dimensional data to the server device includes sending global positioning system data corresponding to the two dimensional data to the server device. Matching the position of the two dimensional data with the digital surface model includes using global positioning system data to locate a general area of the digital surface map and then determining an orientation of the two dimensional data by mapping a landmark of the two dimensional data and the digital surface model. The three dimensional data is rendered on the server. The method further comprises sending the three dimensional data to a display and rendering the three dimensional data on the display. Device settings information is used in matching the position of the two dimensional data with the digital surface model. The device settings information comprise at least one of compass information, lens information, zoom information and gyroscope information. The two dimensional data is selected from the group consisting of an image and a video.

In another aspect, a system for converting two dimensional data to three dimensional data programmed in a memory in a device comprises an acquisition module for acquiring the two dimensional data, a depth map generation module for generating a depth map using global positioning system data and a digital surface model and a two dimensional to three dimensional conversion module for converting the two dimensional data to three dimensional data using the depth map. The acquisition module is further for acquiring the global positioning system data and the digital surface model. The depth map generation module uses the global positioning system data to position a virtual camera and determine a distance from the virtual camera and the digital surface model. The depth map generation module uses device settings information to position of the two dimensional data with the digital surface model. The device settings information comprise at least one of compass information, lens information, zoom information and gyroscope information. The two dimensional data is selected from the group consisting of an image and a video.

In another aspect, a camera device comprises an image acquisition component for acquiring a two dimensional image, a memory for storing an application, the application for determining a configuration of the two dimensional image on a digital surface model using global positioning system data, determining distances of objects in the two dimensional imaging and the digital surface model, generating a depth map using the distances determined and rendering a three dimensional image using the depth map and the two dimensional image and a processing component coupled to the memory, the processing component for processing the application. Determining the configuration of the two dimensional image on the digital surface model includes using the global positioning system data to locate a general area of the digital surface map and then determining an orientation of the two dimensional image by mapping a landmark of the two dimensional image and the digital surface model. Device settings information is used in determining the configuration of the two dimensional image. The device settings information comprise at least one of compass information, lens information, zoom information and gyroscope information. The camera device further comprises a screen for displaying the three dimensional image converted from the two dimensional image. The camera device further comprises a second memory for storing the three dimensional image. The camera device further comprises a wireless connection to send the three dimensional image to a three dimensional capable display or television. The camera device further comprises a wireless connection to send the three dimensional image to a server or a mobile phone.

### BRIEF DESCRIPTION OF THE DRAWINGS

FIG. 1 illustrates 2D to 3D image conversion according to some embodiments.

FIG. 2 illustrates a system of cloud computing to convert 2D data to 3D data according to some embodiments.

FIG. 3 illustrates a flowchart of a method of converting 2D data to 3D data according to some embodiments.

FIG. 4 illustrates a flowchart of a method of converting 2D data to 3D data using cloud computing according to some embodiments.

FIG. 5 illustrates a block diagram of an exemplary computing device configured to convert 2D data to 3D data according to some embodiments.

### DETAILED DESCRIPTION OF THE PREFERRED EMBODIMENT

Three dimensional (3D) data such as images or videos are able to be generated from two dimensional data (2D) using Global Positioning System (GPS) data and one or more Digital Surface Models (DSMs). DSMs and GPS data are used to position a virtual camera at an appropriate angle and location on the DSM. The distance between the virtual camera to the DSM is used to reconstruct a depth map. The depth map and two dimensional image are used to render a three dimensional image. DSMs, including DSMs for specific landmarks, are able to be pre-loaded on a device such as a camera or camcorder or are able to be obtained from the Internet, wired or wirelessly. In some embodiments, cloud computing is used such that the device is coupled to device such as a computer or a television, and the device sends an image along with GPS data to a server. The server matches the available position and performs depth map reconstruction. Depending on the request, either the server or the television renders the 3D image to the display.

DSMs are topographic maps of the Earth's surface that provide a geometrically correct 3D reference frame over which other data layers are able to be draped. The DSM data includes buildings, vegetation, roads and natural terrain features. Usually DSMs are acquired with Light Detection and Ranging (LIDAR) optical remote sensing technology that measures properties of scattered light to find the range of a distant target.

DSMs are currently used to generate 3D fly-through, support location-based systems, augment simulated environments and conduct various analysis. DSMs are able to be used as a comparatively inexpensive means to ensure that cartographic products such as topographic line maps, or even road maps, have a much higher degree of accuracy than would otherwise be possible.

One of the applications that uses DSMs is Google Earth, which displays satellite images of varying resolution of the Earth's surface, allowing users to see items such as cities and houses looking perpendicularly down or at an oblique angle. Google Earth uses Digital Elevation Model (DEM) data collected by NASA's Shuttle Radar Topography Mission. This enables one to view the Grand Canyon or Mount Everest in 3D instead of 2D.

Google Earth also has the capability to show 3D buildings and structures (such as bridges), which include users' submissions using Sketchup, a 3D modeling program. In prior versions of Google Earth (before Version 4), 3D buildings were limited to a few cities and had poorer rendering with no textures. Many building and structures from around the world now have detailed 3D structures; including, but not limited to, those in the United States, Canada, Ireland, India, Japan, United Kingdom, Germany, Pakistan, and the cities like Amsterdam and Alexandria.

2D to 3D image and video conversion has been a challenging problem. An important aspect of the conversion is generation or estimation of depth information using only a single-view image. If a depth map is available, then stereo views are able to be reconstructed utilizing a system/method to convert a 2D image to a 3D image based on image categorization or from another system/method to convert a single portrait image from 2D to 3D.

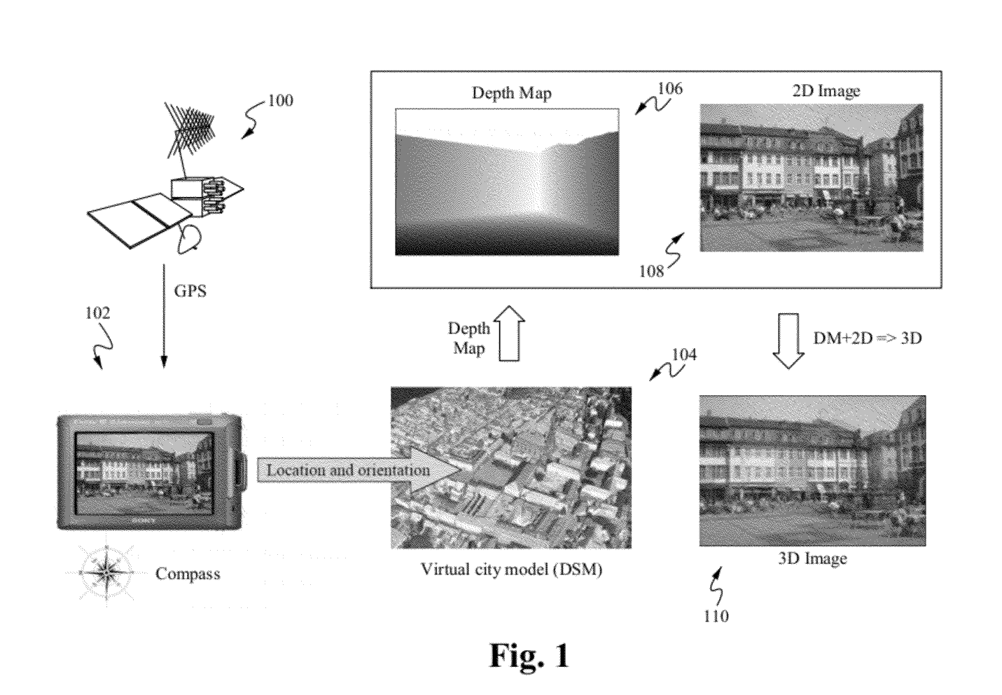

The 2D to 3D image conversion described herein uses available DSMs to generate a depth map of a scene. FIG. 1 illustrates 2D to 3D image conversion according to some embodiments. A satellite 100 provides GPS information to an imaging device 102 such as a camera. In some embodiments, the imaging device 102 includes a compass. In some embodiments, the imaging device 102 includes a gyroscope which is able to provide data that is usable to orient the image such as identifying the vertical angle of the image. GPS, compass and/or gyroscope information is used to position a virtual camera on a DSM 104 of the city or other landmark, and the distance from the virtual camera to the model surfaces is used to reconstruct a depth map 106 of the scene. Then, the depth map 106 and 2D Image 108 are used to render a 3D image 110. Extra objects such as people, cars and others are identified in the image, and if desired, are rendered in 3D separately. DSMs for specific landmarks are able to be pre-loaded on a device or obtained from the Internet.

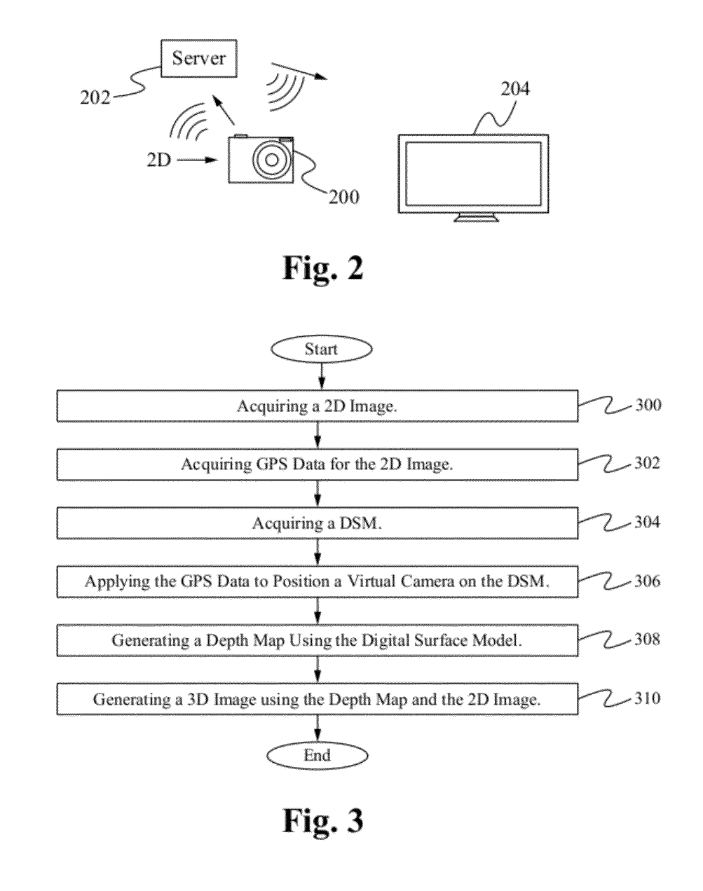

FIG. 2 illustrates a system of cloud computing to convert 2D data to 3D data according to some embodiments. A device 200 sends a 2D image and GPS data to a sever 202. The 2D image and GPS data are acquired by the device 200 in any manner such as by taking a picture with GPS coordinates using the device 200, downloading the 2D image and GPS data, or the 2D image and GPS data being pre-loaded on the device 200. The server 202 then matches the 2D image position with a DSM, and performs depth map reconstruction. In some embodiments, the server 202 uses the depth map and 2D image and renders a 3D image to a display 204 such as a television. In some embodiments, the server 202 sends the depth map and 2D image to the display 204, and the display 204 renders the 3D image.

FIG. 3 illustrates a flowchart of a method of converting 2D data to 3D data according to some embodiments. In the step 300, a 2D image is acquired. In some embodiments, acquiring the image includes a user taking a picture of a location. In some embodiments, the step 300 is skipped, if the image has previously been acquired. In the step 302, GPS data is acquired related to the 2D image. In some embodiments, the GPS data is acquired when the 2D image is acquired. In the step 304, a DSM is acquired. In the step 306, the GPS data is applied to position a virtual camera on the DSM. Positioning the virtual camera includes mapping the 2D image to the DSM. Mapping the 2D image includes using the global positioning system data to locate a general area of the DSM and then determining an orientation of the 2D image by mapping a landmark of the 2D image and the DSM. In the step 308, a depth map is generated using the digital surface model and the 2D image. In some embodiments, the depth map is generated by determining a distance between the digital surface model and the virtual camera. In some embodiments, device settings such as the type of lens used, zoom position, and other settings are used to determine the size of the scene to help generate the depth map. In some embodiments, data from a gyroscope is used to help identify angle data such as the vertical angle of the 2D image. The device settings information, gyroscope data and other information are able to compliment the 2D image and matching of the 2D image with the DSM or skip the matching to directly generate the depth map. In the step 310, a 3D image is generated using the depth map and the 2D image. In some embodiments, the 3D image is then displayed or sent to a device for display. Fewer or additional steps are able to be included. Further, the order of the steps is able to be changed where possible.

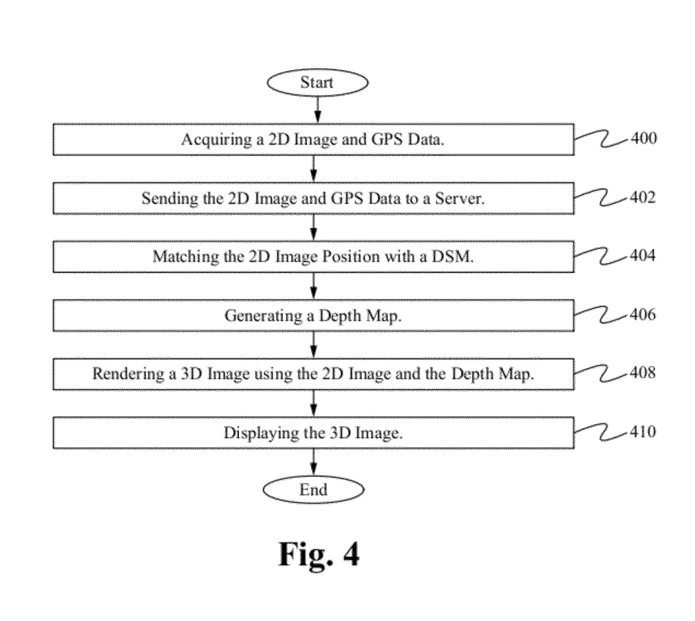

FIG. 4 illustrates a flowchart of a method of converting 2D data to 3D data using cloud computing according to some embodiments. In the step 400, a 2D image and GPS data are acquired. In some embodiments, acquiring the image includes a user taking a picture of a location with GPS coordinates included. In the step 402, the 2D image and the GPS data are sent to a server. In some embodiments, the image and data are sent by any means such as wirelessly uploaded. In FIG. 404, the 2D image position is matched with a DSM. In the step 406, a depth map is generated using the digital surface model and the 2D image. In the step 408, a 3D image is rendered using the depth map and the 2D image. In some embodiments, the 3D image is rendered on the server. In some embodiments, the 3D image is rendered on the display. In the step 410, the 3D image is displayed. Fewer or additional steps are able to be included. Further, the order of the steps is able to be changed where possible.

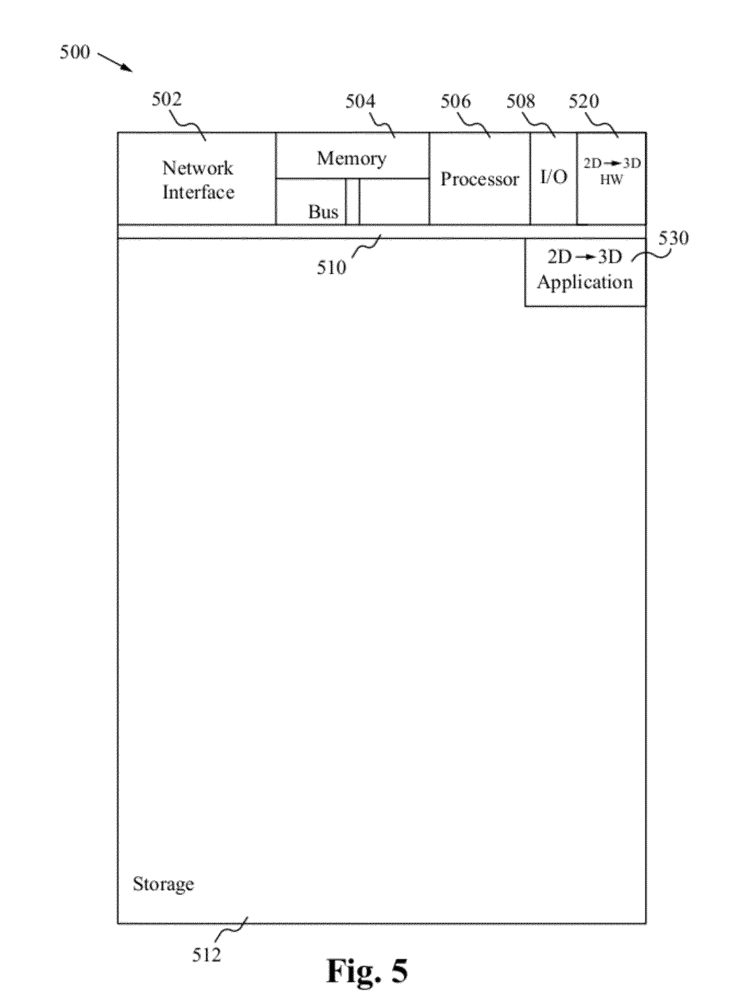

FIG. 5 illustrates a block diagram of an exemplary computing device 500 configured to convert 2D data to 3D data according to some embodiments. The computing device 500 is able to be used to acquire, store, compute, process, communicate and/or display information such as images and videos. For example, a computing device 500 is able to generate a depth map using 2D data, GPS data and a DSM and then convert the 2D data into 3D data for display. In general, a hardware structure suitable for implementing the computing device 500 includes a network interface 502, a memory 504, a processor 506, I/O device(s) 508, a bus 510 and a storage device 512. The choice of processor is not critical as long as a suitable processor with sufficient speed is chosen. The memory 504 is able to be any conventional computer memory known in the art. The storage device 512 is able to include a hard drive, CDROM, CDRW, DVD, DVDRW, flash memory card or any other storage device. The computing device 500 is able to include one or more network interfaces 502. An example of a network interface includes a network card connected to an Ethernet or other type of LAN. The I/O device(s) 508 are able to include one or more of the following: keyboard, mouse, monitor, display, printer, modem, touchscreen, button interface and other devices. In some embodiments, the hardware structure includes multiple processors. 2D to 3D conversion application(s) 530 used to perform the conversion are likely to be stored in the storage device 512 and memory 504 and processed as applications are typically processed. More or less components shown in FIG. 5 are able to be included in the computing device 500. In some embodiments, 2D to 3D conversion hardware 520 is included. Although the computing device 500 in FIG. 5 includes applications 530 and hardware 520 for 2D to 3D conversion, the conversion is able to be implemented on a computing device in hardware, firmware, software or any combination thereof. For example, in some embodiments, the 2D to 3D conversion applications 530 are programmed in a memory and executed using a processor. In another example, in some embodiments, the 2D to 3D conversion hardware 520 is programmed hardware logic. In some embodiments, the computing device includes a second memory for storing the 3D data. In some embodiments, the computing device includes a wireless connection to send the 3D data to a 3D capable display/television, a server and/or a mobile device such as a phone.

In some embodiments, the 2D to 3D conversion application(s) 530 include several applications and/or modules. Modules such as an acquisition module, depth map generation module, 2D to 3D conversion module are able to be implemented. The acquisition module is used to acquire a 2D image, GPS data and/or DSMs. The depth map generation module is used to generate a depth map using the 2D image, GPS data and DSMs. The 2D to 3D conversion module is used to convert the 2D image to a 3D image using the depth map and the 2D image. Other modules such as a device settings module for utilizing device settings such as lens information, focus information, gyroscope information and other information are able to be implemented as well. In some embodiments, modules include one or more sub-modules as well. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a camera, a camcorder, a digital camera, a digital camcorder, a camera phone, an iPod®/iPhone, a video player, a DVD writer/player, a Blu-ray® writer/player, a television, a home entertainment system or any other suitable computing device.

To utilize the 2D-to-3D conversion using GPS and DSM data, a user acquires an image by any means such as taking a picture with a device such as a camera or downloading a picture to the device. GPS and DSM data are acquired and/or pre-loaded on the device. The GPS and DSM data are utilized to convert the image from 2D to 3D without user intervention. The user is then able to view the 3D image on a display.

In operation, the 2D-to-3D conversion using GPS and DSM data enables a user to convert 2D data to 3D data using the GPS data and DSM data. The GPS data determines the location and orientation of the 2D data on the DSM. Using the 2D data and the DSM, a depth map is generated. The depth map and the 2D data are then used to generate the 3D data.

### Some Embodiments of 2D to 3D Image and Video Conversion Using GPS and DSM

1. A device for converting two dimensional data to three dimensional data comprising:
   a. a location component for providing location information of the two dimensional data;
   b. a digital surface model component for providing digital surface information;
   c. a depth map component for generating a depth map of the two dimensional data; and
   d. a conversion component for converting the two dimensional data to the three dimensional data using the depth map.
2. The device of clause 1 further comprising a screen for displaying the three dimensional data.
3. The device of clause 1 wherein the location information comprises global positioning system data.
4. The device of clause 1 wherein the digital surface information comprises a digital surface model.
5. The device of clause 1 wherein generating the depth map comprises utilizing the location information to determine a position of the two dimensional data on the digital surface information and determining distances of elements of the two dimensional data.
6. The device of clause 5 wherein device settings information is used in generating the depth map by helping determine the position of the two dimensional data on the digital surface information.
7. The device of clause 6 wherein the device settings information comprise at least one of compass information, lens information, zoom information and gyroscope information.
8. The device of clause 1 wherein the two dimensional data is selected from the group consisting of an image and a video.
9. A method of converting two dimensional data to three dimensional data programmed in a memory on a device comprising:
   a. acquiring the two dimensional data;
   b. determining a configuration of the two dimensional data on a digital surface model using global positioning system data;
   c. determining distances of objects in the two dimensional data and the digital surface model;
   d. generating a depth map using the distances determined; and
   e. rendering the three dimensional data using the depth map and the two dimensional data.
10. The method of clause 9 further comprising acquiring the digital surface model and the global position system data.
11. The method of clause 9 further comprising displaying the three dimensional data on a display.
12. The method of clause 9 wherein determining the configuration of the two dimensional data on the digital surface model includes using the global positioning system data to locate a general area of the digital surface map and then determining an orientation of the two dimensional data by mapping a landmark of the two dimensional data and the digital surface model.
13. The method of clause 9 wherein device settings information is used in determining the configuration of the two dimensional data on the digital surface model.
14. The method of clause 13 wherein the device settings information comprise at least one of compass information, lens information, zoom information and gyroscope information.
15. The method of clause 9 wherein the two dimensional data is selected from the group consisting of an image and a video.
16. The method of clause 9 wherein determining the configuration, determining the distances, generating the depth map and rendering the three dimensional data occur on at least one of a server device, a camera, a camcorder, a personal computer or a television.
17. A method of converting two dimensional data to three dimensional data comprising:
   a. sending the two dimensional data to a server device;
   b. matching a position of the two dimensional data with a digital surface model;
   c. generating a depth map using the position; and
   d. rendering the three dimensional data using the depth map and the two dimensional data.
18. The method of clause 17 wherein the server device stores the digital surface model.
19. The method of clause 17 wherein sending the two dimensional data to the server device includes sending global positioning system data corresponding to the two dimensional data to the server device.
20. The method of clause 17 wherein matching the position of the two dimensional data with the digital surface model includes using global positioning system data to locate a general area of the digital surface map and then determining an orientation of the two dimensional data by mapping a landmark of the two dimensional data and the digital surface model.
21. The method of clause 17 wherein the three dimensional data is rendered on the server.
22. The method of clause 17 further comprising sending the three dimensional data to a display and rendering the three dimensional data on the display.
23. The method of clause 17 wherein device settings information is used in matching the position of the two dimensional data with the digital surface model.
24. The method of clause 23 wherein the device settings information comprise at least one of compass information, lens information, zoom information and gyroscope information.
25. The method of clause 17 wherein the two dimensional data is selected from the group consisting of an image and a video.
26. A system for converting two dimensional data to three dimensional data programmed in a memory in a device comprising:
   a. an acquisition module for acquiring the two dimensional data;
   b. a depth map generation module for generating a depth map using global positioning system data and a digital surface model; and
   c. a two dimensional to three dimensional conversion module for converting the two dimensional data to three dimensional data using the depth map.
27. The system of clause 26 wherein the acquisition module is further for acquiring the global positioning system data and the digital surface model.
28. The system of clause 26 wherein the depth map generation module uses the global positioning system data to position a virtual camera and determine a distance from the virtual camera and the digital surface model.
29. The system of clause 26 wherein the depth map generation module uses device settings information to position of the two dimensional data with the digital surface model.
30. The system of clause 29 wherein the device settings information comprise at least one of compass information, lens information, zoom information and gyroscope information.
31. The system of clause 26 wherein the two dimensional data is selected from the group consisting of an image and a video.
32. A camera device comprising:
   a. an image acquisition component for acquiring a two dimensional image;
   b. a memory for storing an application, the application for:
      i. determining a configuration of the two dimensional image on a digital surface model using global positioning system data;
      ii. determining distances of objects in the two dimensional imaging and the digital surface model;
      iii. generating a depth map using the distances determined; and
      iv. rendering a three dimensional image using the depth map and the two dimensional image; and
   c. a processing component coupled to the memory, the processing component for processing the application.
33. The camera device of clause 32 wherein determining the configuration of the two dimensional image on the digital surface model includes using the global positioning system data to locate a general area of the digital surface map and then determining an orientation of the two dimensional image by mapping a landmark of the two dimensional image and the digital surface model.
34. The camera device of clause 32 wherein device settings information is used in determining the configuration of the two dimensional image.
35. The camera device of clause 34 wherein the device settings information comprise at least one of compass information, lens information, zoom information and gyroscope information.
36. The camera device of clause 32 further comprising a screen for displaying the three dimensional image converted from the two dimensional image.
37. The camera device of clause 32 further comprising a second memory for storing the three dimensional image.
38. The camera device of clause 32 further comprising a wireless connection to send the three dimensional image to a three dimensional capable display or television.
39. The camera device of clause 32 further comprising a wireless connection to send the three dimensional image to a server or a mobile phone.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A device for converting two dimensional data to three dimensional data comprising:
a. a location component for providing location information of the two dimensional data;
b. a digital surface model component for providing digital surface information;
c. a depth map component for generating a depth map of the two dimensional data; and
d. a conversion component for converting the two dimensional data to the three dimensional data using the depth map.

2. The device of claim 1 further comprising a screen for displaying the three dimensional data.

3. The device of claim 1 wherein the location information comprises global positioning system data.

4. The device of claim 1 wherein the digital surface information comprises a digital surface model.

5. The device of claim 1 wherein generating the depth map comprises utilizing the location information to determine a position of the two dimensional data on the digital surface information and determining distances of elements of the two dimensional data.

6. The device of claim 5 wherein device settings information is used in generating the depth map by helping determine the position of the two dimensional data on the digital surface information.

7. The device of claim 6 wherein the device settings information comprise at least one of compass information, lens information, zoom information and gyroscope information.

8. The device of claim 1 wherein the two dimensional data is selected from the group consisting of an image and a video.

9. A method of converting two dimensional data to three dimensional data programmed in a memory on a device comprising:
a. acquiring the two dimensional data;
b. determining a configuration of the two dimensional data on a digital surface model using global positioning system data;
c. determining distances of objects in the two dimensional data and the digital surface model;
d. generating a depth map using the distances determined; and
e. rendering the three dimensional data using the depth map and the two dimensional data.

10. The method of claim 9 further comprising acquiring the digital surface model and the global position system data.

11. The method of claim 9 further comprising displaying the three dimensional data on a display.

12. The method of claim 9 wherein determining the configuration of the two dimensional data on the digital surface model includes using the global positioning system data to locate a general area of the digital surface map and then determining an orientation of the two dimensional data by mapping a landmark of the two dimensional data and the digital surface model.

13. The method of claim 9 wherein device settings information is used in determining the configuration of the two dimensional data on the digital surface model.

14. The method of claim 13 wherein the device settings information comprise at least one of compass information, lens information, zoom information and gyroscope information.

15. The method of claim 9 wherein the two dimensional data is selected from the group consisting of an image and a video.

16. The method of claim 9 wherein determining the configuration, determining the distances, generating the depth map and rendering the three dimensional data occur on at least one of a server device, a camera, a camcorder, a personal computer or a television.

17. A method of converting two dimensional data to three dimensional data comprising:
a. sending the two dimensional data to a server device;
b. matching a position of the two dimensional data with a digital surface model;
c. generating a depth map using the position; and
d. rendering the three dimensional data using the depth map and the two dimensional data.

18. The method of claim 17 wherein the server device stores the digital surface model.

19. The method of claim 17 wherein sending the two dimensional data to the server device includes sending global positioning system data corresponding to the two dimensional data to the server device.

20. The method of claim 17 wherein matching the position of the two dimensional data with the digital surface model includes using global positioning system data to locate a general area of the digital surface map and then determining an orientation of the two dimensional data by mapping a landmark of the two dimensional data and the digital surface model.

21. The method of claim 17 wherein the three dimensional data is rendered on the server.

22. The method of claim 17 further comprising sending the three dimensional data to a display and rendering the three dimensional data on the display.

23. The method of claim 17 wherein device settings information is used in matching the position of the two dimensional data with the digital surface model.

24. The method of claim 23 wherein the device settings information comprise at least one of compass information, lens information, zoom information and gyroscope information.

25. The method of claim 17 wherein the two dimensional data is selected from the group consisting of an image and a video.

26. A system for converting two dimensional data to three dimensional data programmed in a memory in a device comprising:
a. an acquisition module for acquiring the two dimensional data;
b. a depth map generation module for generating a depth map using global positioning system data and a digital surface model; and
c. a two dimensional to three dimensional conversion module for converting the two dimensional data to three dimensional data using the depth map.

27. The system of claim 26 wherein the acquisition module is further for acquiring the global positioning system data and the digital surface model.

28. The system of claim 26 wherein the depth map generation module uses the global positioning system data to position a virtual camera and determine a distance from the virtual camera and the digital surface model.

29. The system of claim 26 wherein the depth map generation module uses device settings information to position of the two dimensional data with the digital surface model.

30. The system of claim 29 wherein the device settings information comprise at least one of compass information, lens information, zoom information and gyroscope information.

31. The system of claim 26 wherein the two dimensional data is selected from the group consisting of an image and a video.

32. A camera device comprising:
a. an image acquisition component for acquiring a two dimensional image;
b. a memory for storing an application, the application for:
i. determining a configuration of the two dimensional image on a digital surface model using global positioning system data;
ii. determining distances of objects in the two dimensional imaging and the digital surface model;
iii. generating a depth map using the distances determined; and
iv. rendering a three dimensional image using the depth map and the two dimensional image; and
c. a processing component coupled to the memory, the processing component for processing the application.

33. The camera device of claim 32 wherein determining the configuration of the two dimensional image on the digital surface model includes using the global positioning system data to locate a general area of the digital surface map and then determining an orientation of the two dimensional image by mapping a landmark of the two dimensional image and the digital surface model.

34. The camera device of claim 32 wherein device settings information is used in determining the configuration of the two dimensional image.

35. The camera device of claim 34 wherein the device settings information comprise at least one of compass information, lens information, zoom information and gyroscope information.

36. The camera device of claim 32 further comprising a screen for displaying the three dimensional image converted from the two dimensional image.

37. The camera device of claim 32 further comprising a second memory for storing the three dimensional image.

38. The camera device of claim 32 further comprising a wireless connection to send the three dimensional image to a three dimensional capable display or television.

39. The camera device of claim 32 further comprising a wireless connection to send the three dimensional image to a server or a mobile phone.
